(19) United States
(12) Patent Application Publication
(10) Pub. No.: US 2023/0235256 A1
(43) Pub. Date: Jul. 27, 2023

(54) LAUNDRY COMPOSITION

(71) Applicant: Conopco, Inc., d/b/a UNILEVER, Englewood Cliffs, NJ (US)

(72) Inventors: Yanchao CHEN, Shanghai (CN); Jiemin GE, Shanghai (CN); Jun SHEN, Shanghai (CN); Na XU, Shanghai (CN)

(73) Assignee: Conopco, Inc., d/b/a UNILEVER, Englewood Cliffs, NJ (US)

(21) Appl. No.: 18/011,206

(22) PCT Filed: Jun. 15, 2021
(86) PCT No.: PCT/EP2021/066109

§ 371 Date: Dec. 19, 2022

(30) Foreign Application Priority Data
Jun. 23, 2020 (WO) PCT/CN2020/097804
Aug. 20, 2020 (EP) 20191967.7

(51) Int. Cl. C11D 17/06; C11D 11/00; C11D 1/65; C11D 3/37; C11D 3/22; C11D 3/50

(52) U.S. Cl. CPC C11D 17/06; C11D 11/0017; C11D 1/652; C11D 3/3707; C11D 3/222; C11D 3/505; C11D 11/0082; C11D 1/146

(57) ABSTRACT

Disclosed is a laundry composition comprising a plurality of particles, wherein the particle comprises 30 to 95% of polyethylene glycol by weight of the particle, surfactant selected from anionic surfactant, nonionic surfactant, or a combination thereof, and occlusions of gas and wherein the surfactant is anionic surfactant.

### FIELD OF THE INVENTION

The present invention relates to a laundry composition comprising a plurality of particles which comprise polyethylene glycol as a carrier.

### BACKGROUND OF THE INVENTION

Laundry particles, for example pastilles, may be served as laundry adjunct composition for delivery of laundry benefit agent, particularly for delivery of perfume. However, there remains a need to improve such particles.

The present inventors have recognized there is a need to develop lighter particles. It was surprisingly found that by including certain surfactant into the particle containing polyethylene glycol, the occlusions of gas may be stabilized in the particles and thus the density of the particle is deceased.

### SUMMARY OF THE INVENTION

In a first aspect, the present invention is directed to a laundry composition comprising a plurality of particles, wherein the particle comprises 30 to 95% of polyethylene glycol by weight of the particle, surfactant selected from anionic surfactant, nonionic surfactant, or a combination thereof, and occlusions of gas and wherein the surfactant is anionic surfactant.

In a second aspect, the present invention is directed to a method of forming particles of any embodiment of the first aspect, wherein polyethylene glycol is melted and mixed with surfactant, gas is introduced, and the melted mixture is then formed into particles.

In a third aspect, the present invention is directed to use of a composition of the present invention to impart laundry active agent, preferably perfume to laundered fabrics.

All other aspects of the present invention will more readily become apparent upon considering the detailed description and examples which follow.

### DETAILED DESCRIPTION OF THE INVENTION

Except in the examples, or where otherwise explicitly indicated, all numbers in this description indicating amounts of material or conditions of reaction, physical properties of materials and/or use may optionally be understood as modified by the word “about”.

All amounts are by weight of the composition, unless otherwise specified.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a composition of the invention), such disclosure is also to be considered to apply to any other aspect of the invention (for example a method of the invention) mutatis mutandis.

Polyethylene glycol

The particles of the present invention comprise Polyethylene Glycol (PEG). Polyethylene glycol comes in various weight average molecular weights. A suitable weight average molecular weight of PEG for the purposes of the present invention includes from 4,000 to 12,000, preferably 5,000 to 11,000, more preferably 6,000 to 10,000 and most preferably 7,000 to 9,000. Non-limiting examples of suitable PEG is are: Polyglycol 8000 ex Clariant and Pluriol 8000 ex BASF.

The particle of the present invention comprises no less than 30% of PEG, preferably more than 40% of PEG, more preferably more than 50% of PEG and most preferably more than 60% of PEG by weight of the particle. The particle of the present invention comprises no more than 95% of PEG, preferably less than 85% of PEG, more preferably less than 75% of PEG and most preferably less than 70% of PEG by weight of the particle. Suitably the particle comprises 30 to 95% of PEG, preferably 40 to 85% of PEG, more preferably 50 to 75% by weight of the particle.

### Surfactant

The surfactant comprises anionic surfactant. More preferably the surfactant comprises a combination of anionic surfactant and nonionic surfactant and most preferably the surfactant is a combination of anionic surfactant and nonionic surfactant.

Typically, the amount of surfactant is present in amount of 0.1 to 15%, more preferably 0.4 to 7% and most preferably 1 to 5% by weight of the particle. The weight ratio of the PEG to the surfactant is preferably in amount of 1:1 to 1000:1, more preferably 5:1 to 200:1 and even more preferably 15:1 to 60:1.

Examples of suitable anionic surfactants are the alkyl sulphates, alkyl ether sulphates, soap, alkaryl sulphonates, alkanoyl isethionates, alkyl succinates, alkyl sulphosuccinates, alkyl ether sulphosuccinates, N-alkyl sarcosinates, alkyl phosphates, alkyl ether phosphates, and alkyl ether carboxylic acids and salts thereof, especially their sodium, magnesium, ammonium and mono-, di- and triethanolamine salts. The alkyl and acyl groups generally contain from 8 to 18, preferably from 10 to 16 carbon atoms and may be unsaturated. The alkyl ether sulphates, alkyl ether sulphosuccinates, alkyl ether phosphates and alkyl ether carboxylic acids and salts thereof may contain from 1 to 20 ethylene oxide or propylene oxide units per molecule.

Preferred anionic surfactants comprise alkyl sulfates, alkyl ether sulfates, soap or a mixture thereof. More preferably, anionic surfactants comprise alkyl sulfates, alkyl ether sulfates, or a mixture thereof. These materials have the respective formulae R₂OSO₃M and R₁O (C₂H₄O)ₓSO₃M, wherein R₂ is alkyl or alkenyl of from 8 to 18 carbon atoms, x is an integer having a value of from about 1 to about 10, and M is a cation such as ammonium, alkanolamines, such as triethanolamine, monovalent metals, such as sodium and potassium, and polyvalent metal cations, such as magnesium, and calcium. Most preferably R₂ has 12 to 14 carbon atoms, in a linear rather than branched chain.

More preferred surfactants are selected from sodium lauryl sulphate, sodium lauryl ether sulphate or a mixture thereof. Even more preferred anionic surfactants are selected from sodium lauryl sulphate and sodium lauryl ether sulphate(n)EO, (where n is from 1 to 3), and a mixture thereof; still even more preferably sodium lauryl ether sulphate(n)EO, (where n is from 1 to 3); most preferably sodium lauryl ether sulphate(n)EO where n=1.

Typically, the amount of anionic surfactant is present in amount of 0.1 to 12%, more preferably 0.3 to 6% and most preferably 0.6 to 3% by weight of the particle. The weight ratio of the PEG to the anionic surfactant is preferably in amount of 1:1 to 2000:1, more preferably 10:1 to 200:1 and even more preferably 25:1 to 100:1.

In certain embodiments, the composition comprises a nonionic surfactant. Preferably, the nonionic surfactant comprises: a) the condensation products of aliphatic alcohols having from 8 to 22 carbon atoms in either straight or branched chain configuration with ethylene oxide, such as a coconut alcohol/ethylene oxide condensates having from 2 to 15 moles of ethylene oxide per mole of coconut alcohol; b) condensates of alkylphenols having C6-C15 alkyl groups with 5 to 25 moles of ethylene oxide per mole of alkylphenol; c) alkyl glucoside; d) fatty acid amide, or a mixture thereof. More preferably the nonionic surfactant comprises fatty acid amide, ethoxylated alkyl alcohols, or a combination thereof. Even more preferably the nonionic surfactant comprises fatty acid amide and most preferably the nonionic surfactant is fatty acid amide. Preferably the ethoxylated alkyl alcohol is ethoxylated C₈-C₂₀, more preferably C₈-C₁₆ alkyl alcohols, whereby yet more preferably the average degree of ethoxylation is between 3 and 15, more preferably 5 to 12.

Preferably, the fatty acid amide contains at least 6 carbon atoms. Suitable fatty acid preferably contains from 8 to 24 carbon atoms, preferably from 12 to 20 carbon atoms, and most preferably from 12 to 18 carbon atoms. In the most preferred embodiment of the invention, amides of essential fatty acids are employed. Amides suitable for use in the present invention may be simple amides (i.e., those containing a —CONH₂ group), N-alkyl amides, N, N-dialkyl amides, mono-alkanol amides, and di-alkanol amides. Suitable alkyl or alkanol groups contain from 1 to 30 carbon atoms, preferably from 1 to 20 carbon atoms, and most preferably from 1 to 8 carbon atoms. The preferred amides included in the present invention are mono- and di-alkanol amides, particularly of essential fatty acids. Alkanol amides are more commonly available than alkyl amides.

Preferably, the fatty acid amide is fatty alkanolamides (fatty acid alkanolamides), more preferably C₈ to C₂₀ fatty acid C₁ to C₈ alkanolamide. The preferred fatty acid amides are selected from mono- and diethanolamides of linoleic acid, palmitic acid, and coconut oil. More preferably the fatty acid amide comprises cocamide MEA, cocamide DEA, lauramide DEA, stearamide MEA, myristamide DEA, stearamide DEA, oleylamide DEA, tallowamide DEA, tallowamide MEA, isostearamide DEA, isostearamide MEA, cocamide MIPA, or a mixture thereof. Even more preferably fatty acid amide comprises cocamide MIPA and most preferably the fatty acid amide is cocamide MIPA.

Typically, the amount of nonionic surfactant is present in amount of 0.1 to 8%, more preferably 0.3 to 6% and most preferably 0.6 to 3% by weight of the particle. The weight ratio of the nonionic surfactant to the anionic surfactant is preferably in the range of 1:50 to 50:1, more preferably 15:1 to 1:15 and even more preferably 5:1 to 1:5.

### Occlusions of Gas

To provide suitable mechanical strength and/or improve solubility performance for the particles, the occlusions of gas has an average diameter in the range of 1 to 2000 microns, more preferably 5 to 1000 microns, even more preferably 10 to 500 microns, still even more preferably 20 to 300 microns and most preferably 30 to 150 microns. “Diameter” of the occlusions as used herein means the longest size measurable in any dimension. The value of diameter is reported as a number average diameter if they are expressed in average value, which can be measured, for example by Scanning Electron Microscopy (SEM). Preferably, the occlusion is spherical. Without being bound by any theory or explanation, spherical occlusions of gas may provide improved strength than other shape.

To provide a suitable solubility behavior, preferably the particle comprises 0.1 to 50% of occlusions of gas by volume based on the volume of the particle. More preferably, the particle comprises 0.2 to 20%, even more preferably 0.8 to 15% and most preferably 2 to 10% by volume based on the volume of the particle. Preferably, the occlusions of gas are distributed in the particles.

### Saccharide

To stabilize the occlusions of gas, it is preferable that the particle comprises a saccharide. Saccharides are molecular compounds comprising carbon, hydrogen and oxygen. For sake of clarity, saccharide used herein comprises monosaccharide (e.g. dextrose, fructose, galactose, glucose, isoglucose, sucrose), oligosaccharide, polysaccharide or a mixture thereof. Monosaccharides are simple sugar units having the general formula (CH₂O)ₙ, wherein n is 3, 5 or 6, preferably 5 or 6. Some monosaccharides may be substituted with additional functional groups. An oligosaccharide is a short saccharide polymer comprising between two and ten monosaccharides units. A polysaccharide is a saccharide polymer comprising more than ten monosaccharides units, preferably 15 to 1000 monosaccharides units and more preferably 25 to 500 monosaccharides units.

More preferably, the particle comprises a polysaccharide. Suitable polysaccharides may be selected from starch, glycogen, glucose, chitin, gum Arabic, xanthan gum, cellulose, derivatives thereof, or a combination thereof, preferably the polysaccharide comprises starch, and/or its derivatives, and most preferably the saccharide is starch.

The starch suitable for the present invention may be wheat, rice, potato, tapioca or a combination thereof.

Preferably the polysaccharide has an average diameter of 1 to 500 microns, more preferably 2 to 100 microns. Preferably, the polysaccharide has a weight average molecular weight of 1,000 to 500,000, more preferably 3,000 to 100,000.

Preferably the saccharide used in the present invention is anhydrous, i.e. free of water.

Preferably, the particle comprises saccharide in amount of 0.1 to 20%, more preferably 0.5 to 15%, even more preferably 2 to 9% by weight of the particle. Preferably, the particle comprises polysaccharide in amount of 0.1 to 20%, more preferably 0.5 to 15%, even more preferably 2 to 9% by weight of the particle. Preferably, the particle comprises starch in amount of 0.1 to 20%, more preferably 0.5 to 15%, even more preferably 2 to 9% by weight of the particle.

### Perfume

Preferably, the particle comprises perfume materials. The particles of the present invention may comprise 0.1 to 30% of perfume materials, i.e. free perfume and/or perfume microcapsules, by weight of the particles. As is known in the art, free perfumes and perfume microcapsules provide the consumer with perfume hits at different points during the wash cycle. It is particularly preferred that the particles of the present invention comprise a combination of both free perfume and perfume microcapsules.

Preferably the particle of the present invention comprises 0.5 to 20% of perfume materials, more preferably 1 to 15% of perfume materials, most preferably 2 to 10% of perfume materials by weight of the particle.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

### Free Perfumes

The particle of the present invention preferably comprises 0.1 to 15% of free perfume, more preferably 0.5 to 8% of free perfume by weight of the particle.

Particularly preferred perfume components are blooming perfume components and substantive perfume components. Blooming perfume components are defined by a boiling point less than 250° C. and a LogP or greater than 2.5. Substantive perfume components are defined by a boiling point greater than 250° C. and a LogP greater than 2.5. Boiling point is measured at standard pressure (760 mm Hg). Preferably, a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

### Perfume Microcapsules

The particle of the present invention preferably comprises 0.1 to 15% of perfume microcapsules, more preferably 0.5 to 8% of perfume microcapsules by weight of the particle. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The particles of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Boiling point is measured at standard pressure (760 mm Hg). Preferably, a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

### Additional Carrier

The particles of the present invention may further comprise an additional carrier. The additional carrier material may provide various benefits such as stability benefits. The additional carrier materials may be selected from the group consisting of: polymers (e g, polyethylene glycol, ethylene oxide/propylene oxide block copolymers, polyvinyl alcohol, polyvinyl acetate, and derivatives thereof), proteins (e.g., gelatin, albumin, casein), water-soluble or water dispersible fillers (e.g., sodium chloride, sodium sulfate, sodium carbonate/bicarbonate, zeolite, silica, clay), and combinations thereof.

Examples of suitable additional carrier materials include: water soluble organic alkali metal salt, water soluble inorganic alkaline earth metal salt, water soluble organic alkaline earth metal salt, water soluble carbohydrate, water soluble silicate, water soluble urea, clay, water insoluble silicate, citric acid, carboxymethyl cellulose, fatty acid, fatty alcohol, glyceryl diester of hydrogenated tallow, glycerol, polyvinyl alcohol and combinations thereof.

Amount of the additional carrier may be ranged from 0.1 to 50%, preferably 1 to 35%, and more preferably 2 to 25% by weight of the composition.

Preferably, the particle is substantially free of water. By substantially free, it is meant herein 0 to 2 wt. % of water, more preferably 0 to 0.2 wt. % of water, even more preferably 0 to 0.01 wt. % of water in the particle composition and most preferably free of any water.

### Additional Benefit Agents

The particles of the present invention may comprise perfume as a benefit agent. However, it may be desirable for the particles of the present invention to deliver other or more than one benefit agent to laundered fabrics. The benefit agents may be free in the carrier material i.e. the PEG, or they may be encapsulated. Suitable encapsulating materials are outlined above in relation to perfumes.

### Exemplary Additional Benefit Agent Includes

a) malodour agents for example: uncomplexed cyclodextrin; odor blockers; reactive aldehydes; flavanoids; zeolites; activated carbon; and mixtures thereof
b) dye transfer inhibitors
c) shading dyes
d) silicone oils, resins, and modifications thereof such as linear and cyclic polydimethylsiloxanes, amino-modified, allcyl, aryl, and alkylaryl silicone oils, which preferably have a viscosity of greater than 50,000 cst;
e) insect repellents
f) organic sunscreen actives, for example, octylmethoxy cinnamate;
g) antimicrobial agents, for example, 2-hydroxy-4, 2,4-trichlorodiphenylether;
h) ester solvents; for example, isopropyl myristate;
i) lipids and lipid like substance, for example, cholesterol;
j) hydrocarbons such as paraffins, petrolatum, and mineral oil
k) fish and vegetable oils;
l) hydrophobic plant extracts;
m) waxes;
n) pigments including inorganic compounds with hydrophobically- modified surface and/or dispersed in an oil or a hydrophobic liquid;
o) sugar-esters, such as sucrose polyester (SPE); and
p) colorant.

The particles of the present invention may have the purpose of providing perfume and/or other benefit agent, the primary function is not softening. The particles of the present invention are preferably substantially free of softening actives. By substantially free, it is meant herein 0 to 5 wt. % of softening actives, preferably 0 to 2 wt. %, more preferably 0 to 1 wt. % of the particle composition. The softening actives is typically a quaternary ammonium compound.

### Form of Particles

The particles of the present invention may be in any solid form, for example: powder, pellet, tablet, prill, pastille or extrudate. Preferably the particles are in the form of a pastille. Pastilles can, for example, be produced using ROTOFORMER Granulation Systems ex. Sandvick Materials.

The present invention provides a method of forming particles, wherein polyethylene glycol is melted, and gas is introduced in the presence of surfactant selected from anionic surfactant, nonionic surfactant, or a combination thereof, the melt is then formed into particles.

The polyethylene glycol is suitably melted at a temperature above the melting point of the polyethylene glycol, preferably at least 2° C. above the melting point of the polyethylene glycol, more preferably at least 5° C. above the melting point of the polyethylene glycol. The melting point is the average melting point for the polyethylene glycol used in a particular composition. Preferably, the method comprises the step of i) melting PEG; ii) mixing the melted PEG with surfactant; iii) introducing gas into the mixture under stirring for 1 minute to 2 hours; and iv) forming particle through the melted mixture.

The particles of the present invention are formed from a melt. The particles can for example, be formed into particles by: Pastillation e.g. using a ROTOFORMER ex Sandvick Materials, extrusion, prilling, by using moulds, casting the melt and cutting to size or spraying the melt.

The particles of the present invention are preferably homogeneously structured. By homogeneous, it is meant that there is a continuous phase throughout the particle. There is not a core and shell type structure. The ingredients will be distributed within the continuous phase. The continuous phase is provided predominately by the polyethylene glycol.

### The Particle

The particles may be any shape or size suitable for dissolution in the laundry process. Preferably, each individual particle has a mass of between 0.95 mg to 5 grams, more preferably 0.01 to 1 gram and most preferably 0.02 to 0.5 grams. Preferably each individual particle has a maximum linear dimension in any direction of 10 mm, more preferably 1 to 8 mm and most preferably a maximum linear dimension of 4 to 6 mm.

The shape of the particles may be selected for example from spherical, hemispherical, compressed hemispherical, lentil shaped, oblong, or planar shapes such as petals. A preferred shape for the particles is hemispherical, i.e. a dome shaped wherein the height of the dome is less than the radius of the base. When the particles are compressed hemispherical, it is preferred that diameter of the substantially flat base provides the maximum linear dimension and the height of the particle is 1 to 5 mm, more preferably 2 to 3 mm. the dimensions of the particles of the present invention can be measured using Calipers. Typically, the particles have an average density of less than 1.2 g/cm³, preferably 0.4 to 1.15, more preferably 0.7 to 1.1, even more preferably 0.95 to 1.1 and still even more preferably 1 to 1.05 g/cm³.

### Method of Use

The particles of the present invention are for use in the laundry process. They may be added in the wash phase, second phase or a rinse phase of a wash cycle using a washing machine. Alternatively, the particles may be used in manual hand washing of fabrics. The particles may be used in addition to other laundry products or they may be used as a standalone product.

The particles of the present invention are preferably dosed in a quantity of 1 g to 50 g, more preferably 10 g to 45 g, most preferably 15 g to 40 g.

### Use for the Particles

Typically, the primary use of the particles of the present invention is to impart perfume to laundered fabrics. The perfume is imparted during the laundry process. The particles may be further used to deliver additional benefit agents to fabrics during the laundry process.

The following examples are provided to facilitate an understanding of the invention. The examples are not intended to limit the scope of the claims.

### EXAMPLES

### Example 1

This example demonstrates the effect of type of surfactant on the generation of bubble in the slurry.

TABLE 1

| | Particle (% by weight) | | | | |
|---|---|---|---|---|---|
| Ingredient | A | B | 1 | 2 | 3 |
| PEG 6000 ^{a} | To 100 | To 100 | To 100 | To 100 | To 100 |
| PEG 8000 ^{b} | 30 | 30 | 30 | 30 | 30 |
| Ester quats ^{c} | — | 1.3 | — | — | — |
| Sodium lauryl | — | — | 1.3 | — | 1.3 |
| ether sulphate ^{d} | | | | | |
| Polyoxyethylene | — | — | — | 1.3 | — |
| Lauryl Ether ^{e} | | | | | |
| Cocamide MIPA ^{f} | — | — | — | — | 1.0 |
| Starch | 5.4 | 5.4 | 5.4 | 5.4 | 5.4 |
| Sodium bicarbonate | 3.5 | 3.5 | 3.5 | 3.5 | 3.5 |
| Citric acid | 1.5 | 1.5 | 1.5 | 1.5 | 1.5 |
| Free perfume | 6.0 | 6.0 | 6.0 | 6.0 | 6.0 |
| Perfume microcapsules | 2.5 | 2.5 | 2.5 | 2.5 | 2.5 |

^{a} PEG-6000, supplied by Jiang Su Jia Feng Co. Ltd.
^{b} PEG-8000, supplied by DOW
^{c} Rewoquat WE 28 SH, supplied by Evonik
^{d} SLES, supplied by ZanYu Technology Group Co., Ltd.
^{e} AEO-9, supplied by BASF
^{f} Cocamide MIPA, supplied by Guangzhou Startec Science and Technology Co., Ltd.

A series of particle samples was prepared by following the formulation in Table 1. The PEG was heated in a mixing vessel, with stirring, until molten and homogeneous. The other ingredients were then slowly added with stirring one by one and finally free perfume and perfume microcapsules to form a slurry. Stirring was continued during the addition of the ingredients. The vessel was kept open for air introduction and stirring was maintained until 5 minutes later if there are bubbles or for 60 minutes if there is no bubble in the slurry. Then, the slurry was dipped onto a cold plate by syringe to solidify to form a hemispherical bead, had a largest diameter 4 to 6 mm and height 2 to 3 mm. The observations and densities for the samples were recorded in Table 2.

The bubbles were formed by trapping air from the atmosphere in the slurry. If the bubbles formed are easily broken during the stirring process and the entrapped air is released back into the atmosphere, indicating the amount of air bubbles entrapped in the particles are less stable.

TABLE 2

| | Bubble in | Time to generate | | Density |
|---|---|---|---|---|
| Sample | the slurry | bubble (minutes) | Comments | (g/cm³) |
| A | No | — | — | 1.15 |
| B | No | — | — | 1.13 |
| 1 | Yes | 40 | Large and stable | 0.95 |
| 2 | Yes | 45 | Large and less stable | 0.94 |
| 3 | Yes | 15 | Small and stable | 0.95 |

As shown in Table 2, the bubble was generated in the slurry by including either anionic surfactant, nonionic surfactant, or a combination thereof and resulted in lighter particle.

1. A laundry composition comprising a plurality of particles, wherein the particle comprises:
(a) 30 to 95% of polyethylene glycol by weight of the particle;
(b) surfactant selected from anionic surfactant, nonionic surfactant, or a combination thereof; and
(c) occlusions of gas,
wherein the surfactant is anionic surfactant; and
further wherein the particle comprises saccharides.

2. The composition according to claim 1 wherein the anionic surfactant is selected from alkyl sulfates, alkyl ether sulfates, or a mixture thereof, and the anionic surfactant is sodium lauryl sulfate, sodium lauryl ether sulfate, or a mixture thereof.

3. The composition according to claim 1 wherein the amount of the anionic surfactant is 0.1 to 15% by weight of the particle.

4. The composition according to claim 1 wherein the weight ratio of the polyethylene glycol to the surfactant is in the range of 1:1 to 1000:1.

5. The composition according to claim 1 wherein the occlusion of gas has an average diameter of 1 to 2000 microns.

6. The composition according to claim 1 wherein the particle further comprises a nonionic surfactant.

7. The composition according to claim 1 wherein the saccharides is polysaccharide and preferably are a starch.

8. The composition according to claim 1 wherein the particle comprises a perfume material.

9. The composition according to claim 1 wherein the particle comprises a combination of free perfume and perfume microcapsules.

10. The composition according to claim 1 wherein the particles are pastilles.

11. The composition according to claim 1 wherein the particle has a maximum dimension less than 10 mm.

12. The composition according to claim 1 wherein the particle is homogeneously structured.

13. A method of forming particles according to claim 1, where polyethylene glycol is melted and mixed with surfactant to make a melted mixture, gas is introduced to the melted mixture, and the melted mixture is then formed into particles.

14. The method according to claim 13, wherein the particles formed are a used in a laundry composition.

15. The method according to claim 13 wherein the particles have a maximum dimension from 2 to 6 mm, saccharides are polysaccharides, anionic surfactant is 0.4 to 7% by weight of the particle and the composition comprises a fatty add amide and further wherein polyethylene glycol is present and at a weight ratio of polyethylene glycol to surfactant of 5:1 to 200:1.
